(19) United States
(12) Patent Application Publication
(10) Pub. No.: US 2013/0331991 A1
(43) Pub. Date: Dec. 12, 2013

(54) SELF-PROPELLED ROBOTIC HAND

(71) Applicant: PANASONIC CORPORATION, Osaka (JP)

(72) Inventor: Takashi HORINOUCHI, Osaka (JP)

(73) Assignee: PANASONIC CORPORATION, Osaka (JP)

(21) Appl. No.: 13/961,743

(22) Filed: Aug. 7, 2013

Related U.S. Application Data
(63) Continuation of application No. PCT/JP2012/007316, filed on Nov. 14, 2012.

(30) Foreign Application Priority Data
Dec. 28, 2011 (JP) 2011-289686

(51) Int. Cl. B25J 5/00

(52) U.S. Cl. CPC B25J 5/00; Y10S 901/01
USPC 700/259; 414/744.5; 700/245; 901/1

(57) ABSTRACT

A self-propelled robotic hand includes: a base capable of self-propulsion; an arm attached to the base; a hand attached to the arm for grasping an object; and a base securing unit attached to the base and configured to secure the base in place by electrostatic adhesion to a surface of a structure external to the self-propelled robotic hand.

### CROSS REFERENCE TO RELATED APPLICATIONS

This is a continuation application of PCT International Application No. PCT/JP2012/007316 filed on Nov. 14, 2012, designating the United States of America, which is based on and claims priority of Japanese Patent Application No. 2011-289686 filed on Dec. 28, 2011. The entire disclosures of the above-identified applications, including the specifications, drawings and claims are incorporated herein by reference in their entirety.

### FIELD

The present disclosure relates to self-propelled robotic hands for household use.

### BACKGROUND

Robots have been researched and developed extensively in recent years. Robots, such as those capable of entering and performing tasks in areas that are potentially dangerous for people, and those designed to assist and care for the elderly, for example, have received a great amount of attention.

When a robot having an arm for moving or lifting objects lifts a heavy object with its arm, a load is applied away from the center of gravity of the robot, causing a large moment of force to act upon the robot. As such, to prevent the robot from falling over, it is necessary to secure the robot to the floor by some method or secure the robot in place with a stabilizing counterweight.

Patent Literature (PTL) 1 discloses, as a securing means for securing a robot, a method for securing a robot to a work object by providing the robot with a fastening unit.

### CITATION LIST

### Patent Literature

[PTL 1] Japanese Unexamined Patent Application Publication No. 2007-276063

[PTL 2] Japanese Unexamined Patent Application Publication No. 2009-540785

### SUMMARY

### Technical Problem

The present disclosure provides a light weight, compact robot capable of securing itself in place in a variety of locations.

### Solution to Problem

The self-propelled robotic hand according to an aspect of the present disclosure includes: a base capable of self-propulsion; an arm attached to the base; a hand attached to the arm, the hand being for grasping an object; and a base securing unit attached to the base and configured to secure the base in place by electrostatic adhesion to a surface of a structure external to the self-propelled robotic hand.

### Advantageous Effects

According to the present disclosure, it is possible to realize a self-propelled robotic hand that is light-weight, compact, and capable of securing itself (the base) in place in a variety of locations.

### BRIEF DESCRIPTION OF DRAWINGS

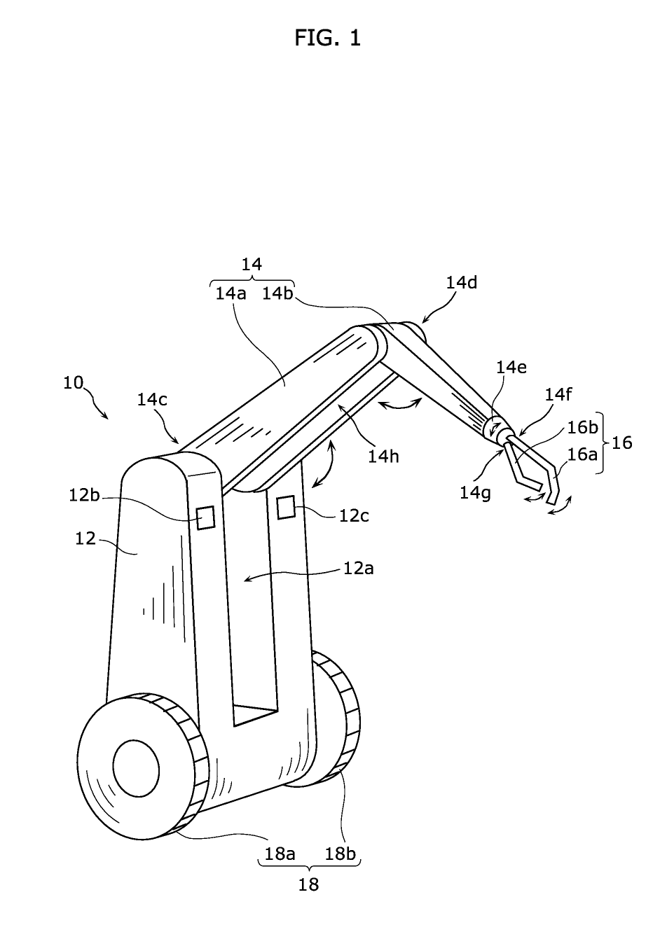

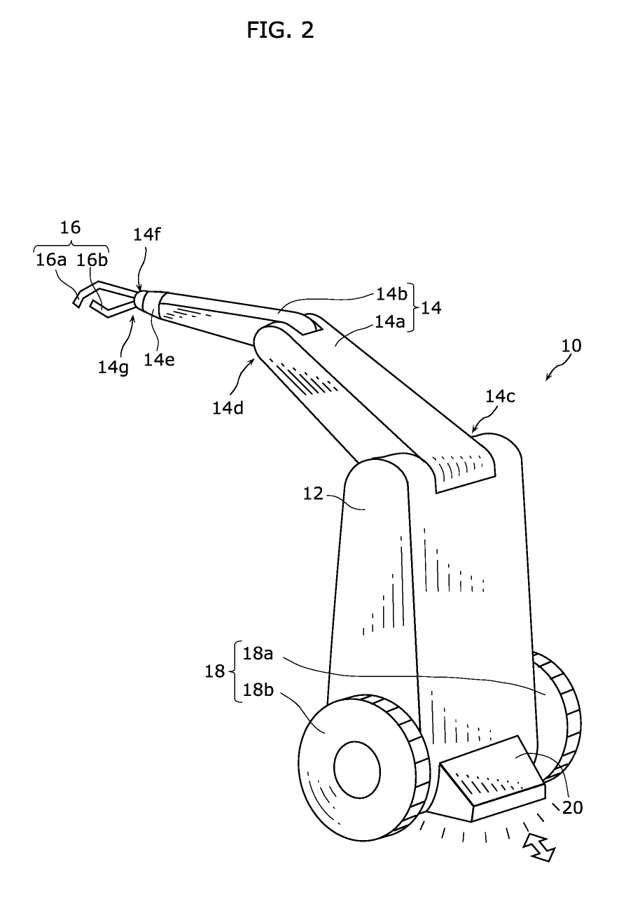

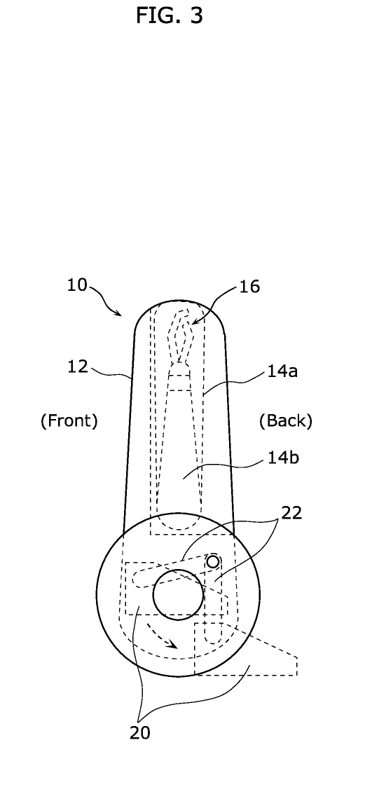

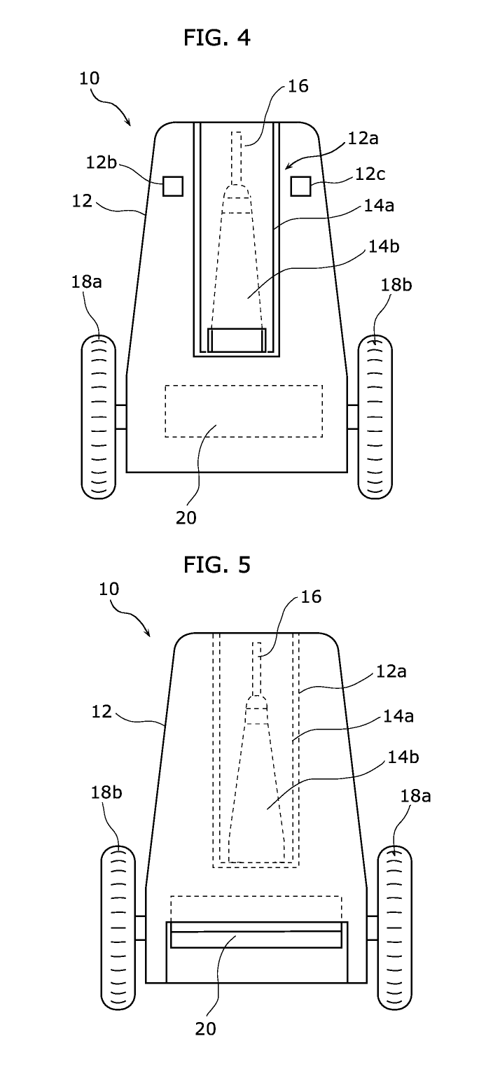

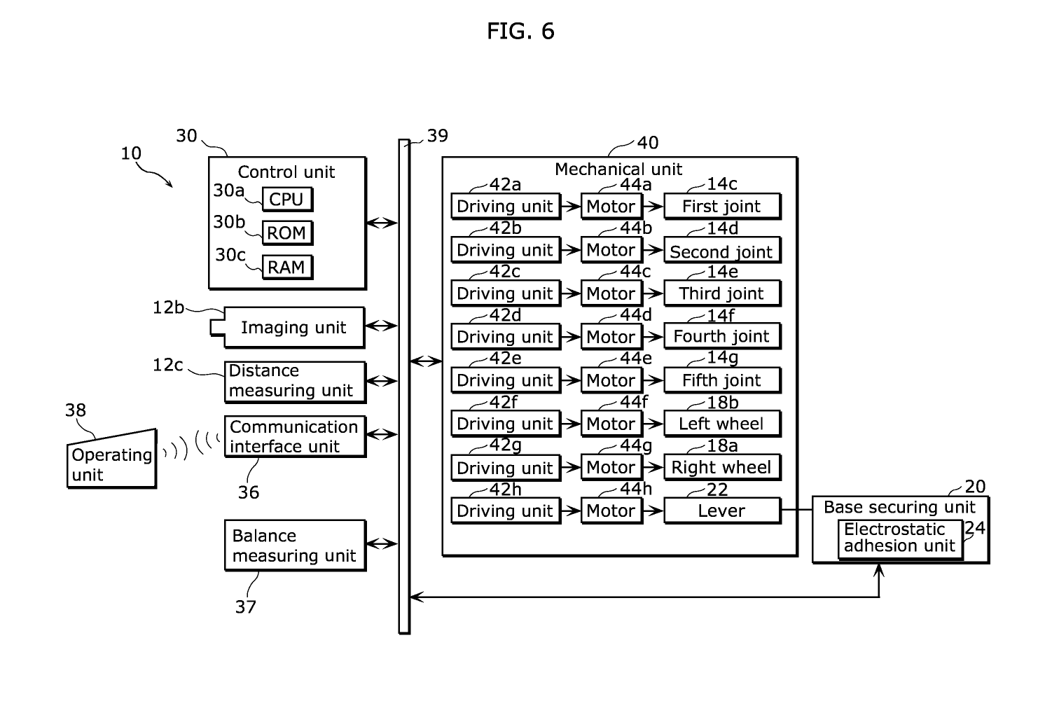

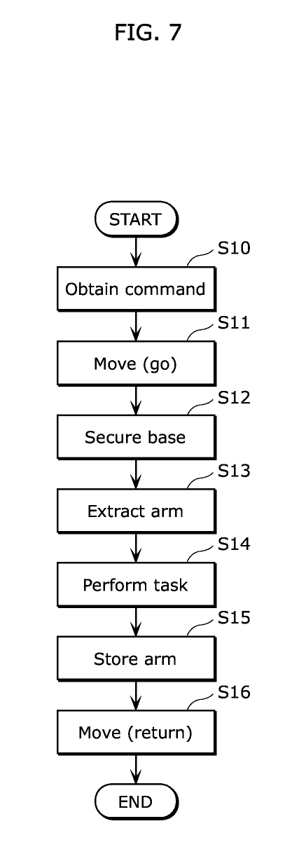

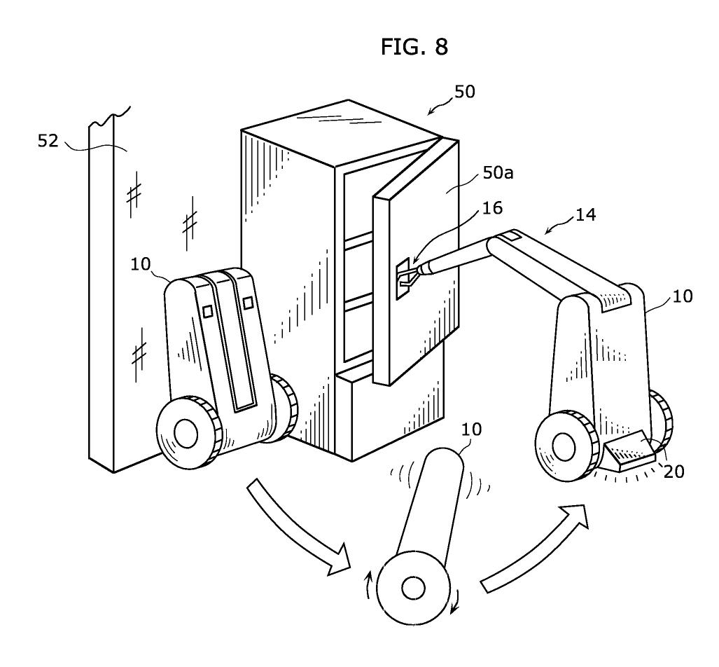

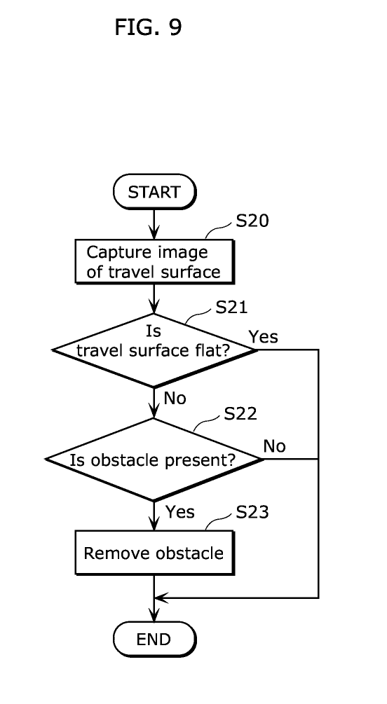

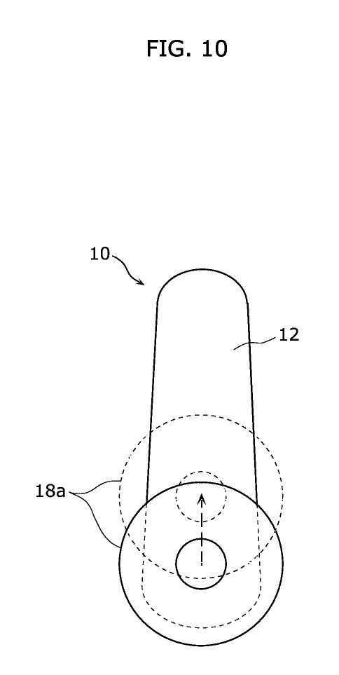

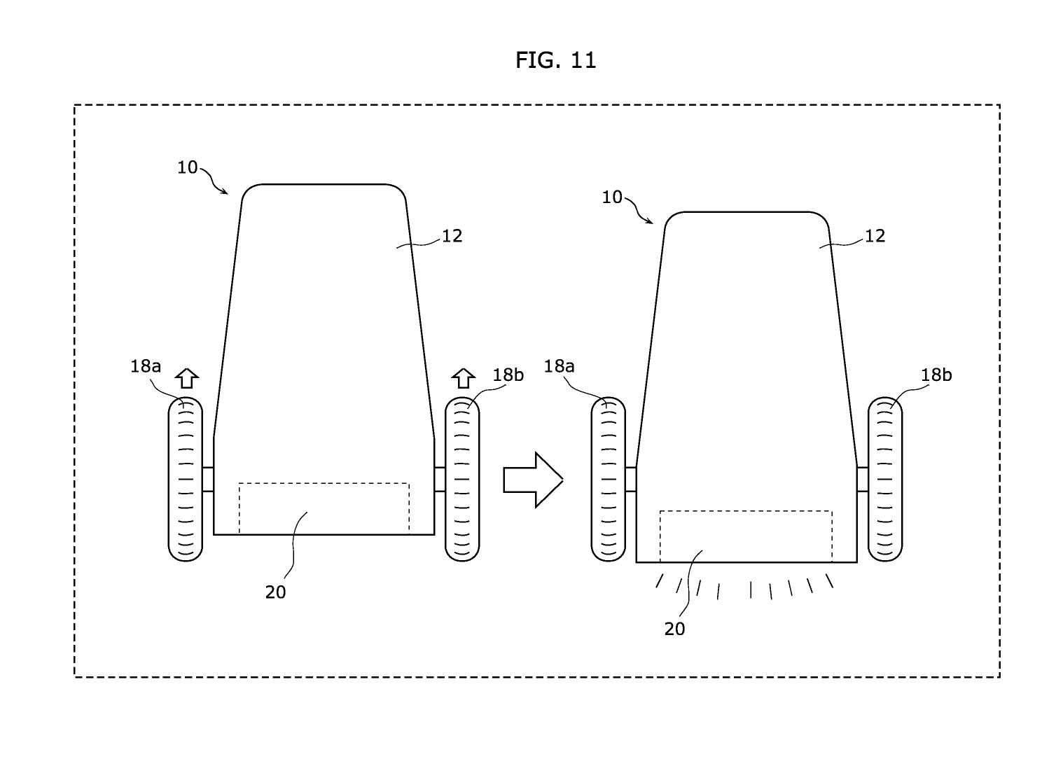

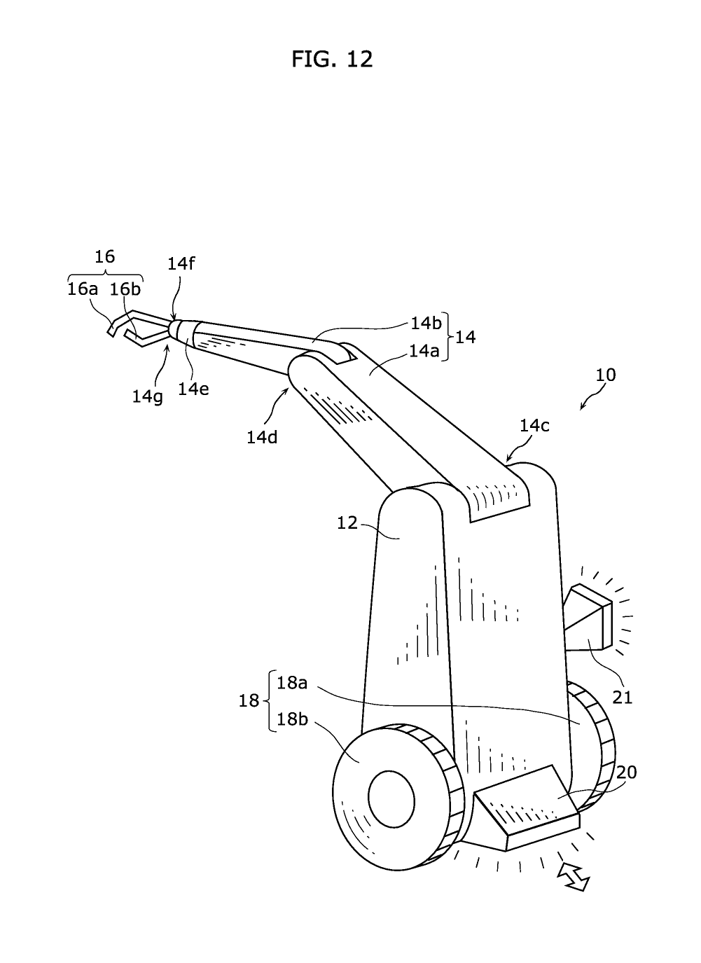

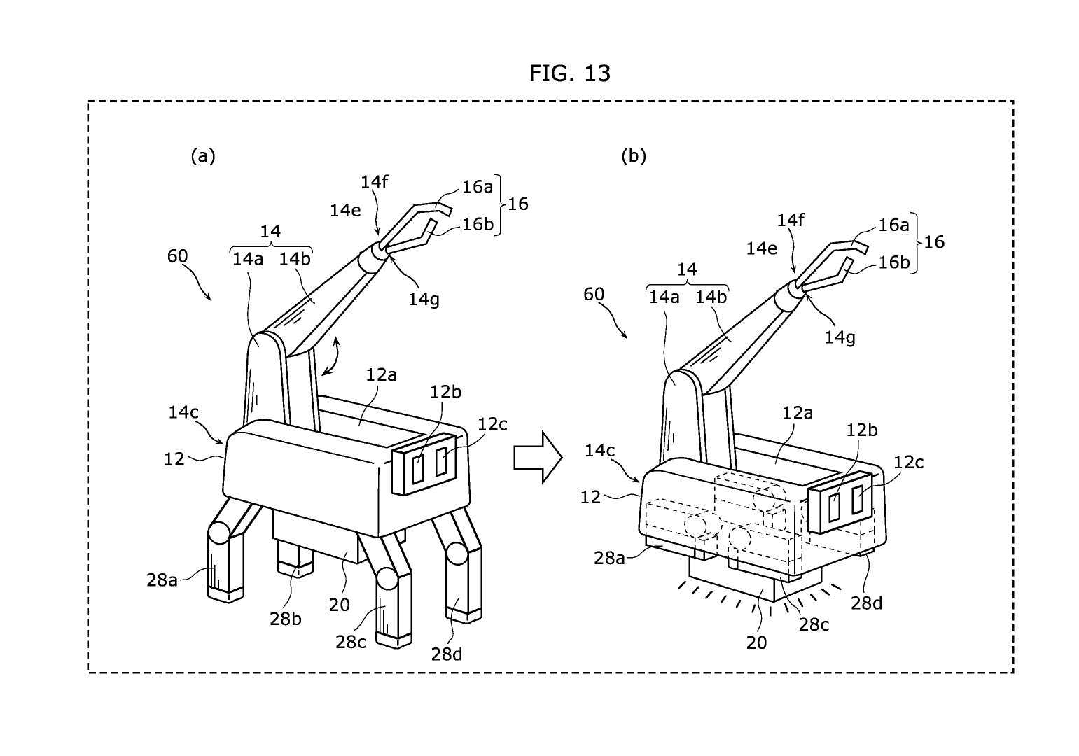

These and other objects, advantages, and features will become apparent from the following description thereof taken in conjunction with the accompanying Drawings, by way of non-limiting examples of an embodiment of the present disclosure.

[FIG. 1] FIG. 1 is a view of the front of the self-propelled robotic hand according to a non-limiting embodiment.

[FIG. 2] FIG. 2 is a view of the back of the self-propelled robotic hand according to a non-limiting embodiment.

[FIG. 3] FIG. 3 is a view of the side of the self-propelled robotic hand while the arm is being stored.

[FIG. 4] FIG. 4 is a view of the front of the self-propelled robotic hand while the arm is being stored.

[FIG. 5] FIG. 5 is a view of the back of the self-propelled robotic hand while the arm is being stored.

[FIG. 6] FIG. 6 is a block diagram showing the system configuration of the self-propelled robotic hand according to a non-limiting embodiment.

[FIG. 7] FIG. 7 is an operational flow chart of the self-propelled robotic hand according to a non-limiting embodiment.

[FIG. 8] FIG. 8 is a view showing an operation performed by the self-propelled robotic hand according to a non-limiting embodiment.

[FIG. 9] FIG. 9 is a flow chart of the obstacle removal operation performed by the self-propelled robotic hand according to a non-limiting embodiment.

[FIG. 10] FIG. 10 is a view showing vertical adjustment of the wheels to control the base securing unit.

[FIG. 11] FIG. 11 is a different view showing vertical adjustment of the wheels to control the base securing unit.

[FIG. 12] FIG. 12 is a view showing an example of the self-propelled robotic hand provided with a base securing unit on a side of the base.

[FIG. 13] FIG. 13 is an external view of the self-propelled robotic hand provided with legs.

### DESCRIPTION OF EMBODIMENT

### (Underlying Knowledge Forming Basis of the Present Disclosure)

As stated in the Background section, a variety of securing means have been proposed for securing robots in place. For example, PTL 1 discloses a method for securing a robot to a work object (an object) by providing the robot with a fastening unit.

However, with the method disclosed in PTL 1, in order to secure the robot provided with a male fastening unit to an object, the object must be fitted with a female fastening unit. As such, the locations in which the robot can perform tasks are limited to locations in which such and object is placed.

PTL 1 also discloses methods for securing the robot to an object using other securing means such as magnets or suction cups.

However, a robot that is light-weight and compact is difficult to realize when magnets are used to secure the robot since a securing means using magnets must be provided. Additionally, the locations in which the robot can perform tasks are limited to locations in which securing with magnets is possible (such as locations where iron plates are attached to the floor).

Moreover, when securing the robot with suction cups by removing the air from inside the suction cups with a pump, a suction pump must additionally be provided as a securing means. In other words, a robot that is light-weight and compact is difficult to realize when a securing means that uses suction cups is provided. Additionally, the locations in which the robot can perform tasks are limited to locations in which securing with suction cups is possible.

In contrast, the self-propelled robotic hand according to an aspect of the present disclosure includes: a base capable of self-propulsion; an arm attached to the base; a hand attached to the arm, the hand being for grasping an object; and a base securing unit attached to the base and configured to secure the base in place by electrostatic adhesion to a surface of a structure external to the self-propelled robotic hand.

In this way, a light-weight and compact self-propelled robotic hand can be realized by using electrostatic adhesion to secure the main body of the robot (the base) in place. Moreover, since electrostatic adhesion is used to secure the base in place, it is possible to secure the base appropriately according to the location. In other words, it is possible to secure the base in place in a variety of locations.

Moreover, the base of the self-propelled robotic hand according to an aspect of the present disclosure may propel itself on a travel surface, and the base securing unit may be attached to a bottom or a side of the base, the bottom being a portion of the base nearest the travel surface.

With this, it is possible to not only secure the base to the surface of travel, but to a surface of a wall, for example, as well.

Moreover, when the self-propelled robotic hand is used inside a building, the surface of the structure to which the base securing unit of the self-propelled robotic hand according to an aspect of the present disclosure electrostatically adheres may be a surface of a floor of the building, a surface of a wall of the building, or a surface of an object installed inside the building.

In this way, since electrostatic adhesion is used to secure the base in place, it is possible to secure the base appropriately according to the location.

Moreover, the base securing unit of the self-propelled robotic hand according to an aspect of the present disclosure may be retractable from the base.

With this, the self-propelled robotic hand is capable of using the base securing unit only at times when it is necessary to secure the base in place.

Moreover, the base of the self-propelled robotic hand according to an aspect of the present disclosure may include a wheel for propelling itself on a travel surface, the wheel being adjustable in a vertical direction, and the base securing unit may be attached to the base in a position which allows the base securing unit to be separated from the travel surface when the wheel is set in a lower end position in the vertical direction and electrostatically adherable to the travel surface when the wheel is set in an upper end position in the vertical direction.

Moreover, the base of the self-propelled robotic hand according to an aspect of the present disclosure may include a storage space for storing the arm and the hand.

With this, the self-propelled robotic hand is even more compact when the arm is stored in the base.

Moreover, the base of the self-propelled robotic hand according to an aspect of the present disclosure may include a control unit configured to turn on and off the electrostatic adhesion of the base securing unit.

In other words, electrostatic adhesion can easily be turned on and off with the provision of the control unit.

Moreover, the self-propelled robotic hand according to an aspect of the present disclosure may further include an imaging unit configured to capture an image of a travel surface on which the base propels itself, wherein the control unit may be configured to confirm whether the travel surface is flat by analyzing the image captured by the imaging unit.

With this, it is possible for the self-propelled robotic hand to confirm whether the travel surface is flat or not.

Moreover, when the control unit of the self-propelled robotic hand according to an aspect of the present disclosure confirms that the travel surface is not flat, the control unit may be configured to determine whether an obstacle is present on the travel surface and, when an obstacle is determined to be present, remove the obstacle using the arm and the hand.

With this, it is possible for the self-propelled robotic hand to propel itself even when an obstacle is present on the travel surface.

Hereinafter, a non-limiting embodiment will be described in detail with reference to the accompanying drawings. However, unnecessarily detailed descriptions may be omitted. For example, detailed descriptions of well-known matters or descriptions of components that are substantially the same as components described previous thereto may be omitted. This is to avoid unnecessary redundancy and provide easily read descriptions for those skilled in the art.

It is to be noted that the non-limiting embodiment described below shows a comprehensive or specific example. The numerical values, shapes, materials, structural elements, the arrangement and connection of the structural elements, steps, the processing order of the steps etc. shown in the following non-limiting, exemplary embodiment are mere examples, and therefore do not limit the present disclosure. Among the structural elements in the following non-limiting, exemplary embodiment, structural elements not recited in any one of the independent claims defining the most generic part of the inventive concept are described as arbitrary structural elements of the non-limiting embodiment.

### Embodiment

First, the robotic hand according to this non-limiting embodiment will be described using FIG. 1 and FIG. 2.

FIG. 1 is a view of the front of the self-propelled robotic hand 10 according to this non-limiting embodiment.

FIG. 2 is a view of the back of the self-propelled robotic hand 10 according to this non-limiting embodiment.

As FIG. 1 and FIG. 2 show, the self-propelled robotic hand 10 includes a base 12 which propels itself on a travel surface, an arm 14, a hand 16 which grasps an object, and a base securing unit 20. It should be noted that self propulsion refers to the self-propelled robotic hand 10 traveling without assistance from any object other than the self-propelled robotic hand 10. Self propulsion includes the self-propelled robotic hand 10 traveling as a result of a user operating the self-propelled robotic hand 10 via a wired or wireless connection.

The self-propelled robotic hand 10 according to this non-limiting embodiment is a household-use robot designed to be used mainly for household (inside a building) purposes, and is a self-propelled robot which performs a task involving an object located in front of the robot. It should be noted that the self-propelled robotic hand 10 is operated via remote control by a user.

The base 12 which propels itself on a travel surface is the main body of the self-propelled robotic hand 10 and is designed to be light weight, compact, and storable in spaces between consumer electronics or furniture, for example.

The base 12 has six surfaces, each surface being trapezoidal or rectangular in shape (in other words, the base 12 is a substantially rectangular solid). Each surface is a flat plane except for the upper surface (a surface on the side on which the arm 14 is coupled), which is rounded. The base 12 has a shape similar to commercially available household vacuum cleaners.

Resin is typically used as the material for the base 12, but usable materials are not limited thereto. For example, a light-weight metal may be used. Moreover, as will be described later, since the base 12 includes a storage space 12a for storing the arm 14 and the hand 16, the arm 14 can be folded and stored in the base 12. The storage space 12a is capable of storing a forearm 14b and the hand 16 while they are folded in an upper arm cavity 14h.

The base 12 includes, on the front surface thereof, an imaging unit 12b and a distance measuring unit 12c.

The imaging unit 12b captures an image of the travel surface on which the self-propelled robotic hand 10 propels itself, and is, for example, a CMOS camera. Moreover, the imaging unit 12b is capable of freely adjusting the image capturing direction. As such, the imaging unit 12b is capable of capturing an image of what is in front of the self-propelled robotic hand 10 as well. It should be noted that the imaging unit 12b may use a charge coupled device (CCD). Moreover, by providing the imaging unit 12b with a lighting device such as a light emitting diode (LED), the imaging unit 12b becomes capable of capturing a clear image even when the area surrounding the self-propelled robotic hand 10 is dark.

The distance measuring unit 12c measures the distance between the self-propelled robotic hand 10 and an object located in front of the self-propelled robotic hand 10, and is, for example, an ultrasonic sensor. It should be noted that the distance measuring unit 12c may be a displacement sensor or the like which uses an infrared laser. Moreover, when the self-propelled robotic hand is to be mainly used outdoors, the distance measuring unit 12c may further be configured to include a global positioning system (GPS).

Wheels 18 (a right wheel 18a and a left wheel 18b) are provided toward the bottom of the base 12. The right wheel 18a is positioned toward the bottom of the right side of the base 12, and the left wheel 18b is positioned toward the bottom of the left side of the base 12. The right wheel 18a and the left wheel 18b are both circular and have the same diameter, and are provided with non-slip grooves on the contact surfaces thereof. Resin is typically used as the material for the right wheel 18a and the left wheel 18b, but usable materials are not limited thereto.

The self-propelled robotic hand 10 travels by a driving unit installed in the base 12 rotating the wheels 18. The self-propelled robotic hand 10 travels while the end of the base 12 on which a first joint is provided is on top and the end of the base 12 on which the wheels 18 are provided is on bottom, as FIG. 1 shows.

While traveling in this state, the self-propelled robotic hand 10 adjusts the rotation of the wheels 18 to maintain the stability of the center of gravity of the self-propelled robotic hand. This allows the self-propelled robotic hand 10 to travel in a stable manner without falling over despite the use of only two wheels.

It should be noted that in the examples shown in FIG. 1 and FIG. 2, the self-propelled robotic hand 10 is configured having two wheels—the right wheel 18a and the left wheel 18b—but the self-propelled robotic hand 10 may be configured to have three or more wheels.

Moreover, the self-propelled robotic hand 10 is not limited to wheels as a means for travel. For example, the self-propelled robotic hand 10 may be provided with caterpillar tracks for traveling. The self-propelled robotic hand 10 may also be provided with legs and configured to walk, for example.

The arm 14 attached to the top of the base 12 is a multi-jointed arm configured of an upper arm 14a, the forearm 14b, and a plurality of joints (the first joint 14c through fifth joint 14g). The joints on the arm 14 include a joint that couples the base 12 and the arm 14, a joint that couples the upper arm 14a and the forearm 14b that make up the arm 14, and a joint that couples the arm 14 and the hand 16.

Moreover, the hand 16 is coupled to the leading end of the arm 14. The self-propelled robotic hand 10 performs a task involving an object positioned in front of it by moving the arm 14 and the hand 16.

The forearm 14b of the arm 14 is a long, thin structure having six surfaces. Assuming the length of the six sided structure to be the vertical direction, the four side surfaces of the six sided structure are long in height relative to the length of the top and bottom, and are substantially the same trapezoidal shape. Assuming the length of the six sided structure to be the vertical direction, the top and bottom surfaces are substantially rectangular in shape.

Resin is typically used as the material for the arm 14, but usable materials are not limited thereto. For example, a light-weight metal may be used. It should be noted that the arm 14 and the hand 16 are storable in the base 12. Storage of the arm 14 and the hand 16 will be described later.

One end of the upper arm 14a is coupled to the base 12 via the first joint 14c. In other words, the first joint is a joint which couples the base 12 and the arm 14. As such, the arm 14 is bendable at the first joint 14c.

The other end of the upper arm 14a is coupled to one end of the forearm 14b via the second joint 14d. In other words, the second joint is a joint which couples the upper arm 14a and the forearm 14b that make up the arm 14. As such, the arm 14 is bendable at the second joint 14d.

It should be noted that the moveable range (the range of bendability) of the arm 14 in the front of the self-propelled robotic hand 10 shown in FIG. 1 is wide and ability to bend is free. On the other hand, the moveable range of the arm 14 behind the self-propelled robotic hand 10 shown in FIG. 2 is narrow and ability to bend is limited.

The third joint 14e, the fourth joint 14f, and the fifth joint 14g are joints that couple the arm 14 and the hand 16.

The third joint 14e is coupled to the other end of the forearm 14b. The third joint 14e rotates in the direction of the arrows in FIG. 1 This allows the hand 16 coupled to the third joint 14e to rotate and grasp objects in a variety of directions.

The hand 16 is a member which is attached to the arm 14 and is capable of grasping an object. The hand 16 is configured of a long finger 16a and a short finger 16b.

The long finger 16a is coupled to the hand 16 via the fourth joint 14f, and the short finger 16b is coupled to the hand 16 via the fifth joint 14g. As such, the long finger 16a is bendable at the fourth joint 14f and the short finger 16b is bendable at the fifth joint 14g.

This allows the self-propelled robotic hand 10 to grasp an object with the long finger 16a and the short finger 16b.

It should be noted that the hand 16 may adhere to an object using an electrostatic adhesion unit (to be described later), an electromagnet, or a pump. In other words, the hand 16 is not limited to a configuration which includes the long finger 16a and the short finger 16b. The configuration of the hand 16 may be any configuration as long as the hand 16 is capable of grasping an object.

The upper arm 14a is provided with an upper arm cavity 14h. The upper arm cavity 14h functions as a storage space for the forearm 14b, the third joint 14e, the fourth joint 14f, the fifth joint 14g, and the hand 16 for when the arm 14 is to be folded and stored in the base 12.

It should be noted that the self-propelled robotic hand 10 may be provided with a plurality of arms 14.

The base securing unit 20 is attached to the bottom (bottom surface) of the base 12. The electrostatic adhesion unit included in base securing unit 20 secures the base 12 in place by electrostatically adhering to a surface of a structure external to the self-propelled robotic hand 10. The surface of the structure is, for example, a surface of a floor or a surface of a refrigerator chassis (to be described later). In this non-limiting embodiment, the base securing unit 20 is attached to the lower portion of the back surface of the self-propelled robotic hand 10, but the position is not limited thereto.

Here, securing the base 12 means securely fixing the base 12 in place to keep forces applied to the base 12 from hindering the self-propelled robotic hand 10 from performing a given task. For example, when the self-propelled robotic hand 10 attempts to lift a heavy object with the arm 14 and a load is applied away from the center of gravity of the base 12, securing the base 12 means making sure the base is stable and does not move (fall over) so that the arm 14 is capable of lifting the heavy object. Moreover, electrostatic adhesion means mechanically bonding two objects using electrostatic energy, and means substantially the same thing as electrostatic absorption.

An electrostatic adhesion apparatus such as the one disclosed in PTL 2 (Japanese Unexamined Patent Application Publication No. 2009-540785), for example, is used in the base securing unit 20. With the electrostatic adhesion apparatus disclosed in PTL 2, it is possible to secure and free the base 12 with electrostatic adhesion by turning the application of voltage on and off, respectively. It should be noted that the electrostatic adhesion apparatus disclosed in PTL 2 is capable of supporting a load of approximately 100 g when the adhesion surface area with respect to the structure is 1 cm² and a load of approximately 8 kg when the adhesion surface area with respect to the structure is 100 cm².

In this way, by using the base securing unit 20 having an electrostatic adhesion unit for securing the base 12 in place, it is possible to secure the base 12 in place with electrostatic energy. A self-propelled robotic hand 10 that is light weight and compact can be achieved when this kind of structure is used for the base securing unit 20 since there is no need to add mechanisms, electromagnets, or pumps, for example, for securing the base 12 in place.

Moreover, when the self-propelled robotic hand 10 is used indoors, the surface of the structure to which the base securing unit 20 electrostatically adheres is a surface of a floor of the building, a surface of a wall of the building, or a surface of an object installed inside the building.

The base securing unit 20 is capable of electrostatically adhering to structures of various materials and securing the self-propelled robotic hand 10 in place. Moreover, for example, by making the electrostatic adhesion unit, which is the surface of the base securing unit 20 which adheres to a structure, a caterpillar track, the base securing unit 20 is capable of securing the base 12 in place even on uneven surfaces. In other words, the self-propelled robotic hand 10 is capable of securing the base with the base securing unit 20 appropriately according to the place of use.

Moreover, the base securing unit 20 is retractable from and storable in the base 12. As such, the height of the electrostatic adhesion unit of the base securing unit 20 is higher than the height of the contact surface of the wheels 18 while the self-propelled robotic hand 10 is traveling. In other words, the base securing unit 20 does not hinder the traveling ability of the self-propelled robotic hand 10.

Next, the state of the self-propelled robotic hand 10 while it is storing the arm 14 and the base securing unit 20 in the base 12 will be described.

FIG. 3, FIG. 4 and FIG. 5 are views of the side, front, and back of the self-propelled robotic hand 10, respectively, while the arm 14 is being stored.

The forearm 14b and the hand 16 are stored in the upper arm cavity 14h provided in the upper arm 14a with use of the second joint 14d. For this reason, the vertical length of the upper arm cavity 14h is longer than the overall length of the forearm 14b and the hand 16.

The upper arm 14a stores the forearm 14b and the hand 16 in the upper arm cavity 14h, and the upper arm 14a is then stored in the storage space 12a provided in the base 12 with the use of the first joint 14c.

As FIG. 4 shows, when the self-propelled robotic hand 10 is viewed from the front while the self-propelled robotic hand 10 is storing the arm 14, the arm 14 is folded and stored so as to be one with the base 12.

The base securing unit 20 includes a foldable lever 22 which folds to store the base securing unit 20. The lever 22 and the base securing unit 20 are configured in such a way so as not to interfere with the rotary shaft of the right wheel 18a and the left wheel 18b.

As FIG. 5 shows, when the self-propelled robotic hand 10 is viewed from the back while the self-propelled robotic hand 10 is storing the base securing unit 20, the height of the adhesive surface of the base securing unit 20 is higher than the contact surface of the wheels 18.

By storing the arm 14 and the base securing unit 20 in the base in the manner described above, an even more compact self-propelled robotic hand 10 is achievable.

Next, the system configuration of the self-propelled robotic hand 10 will be described.

FIG. 6 is a block diagram showing the system configuration of the self-propelled robotic hand according to this non-limiting embodiment.

The self-propelled robotic hand 10 includes, in the base 12, a control unit 30, the imaging unit 12b, the distance measuring unit 12c, a communication interface unit 36, a mechanical unit 40, the base securing unit 20, and a balance measuring unit 37.

The control unit 30 is a computer system configured from a CPU 30a, a ROM 30b, a RAM 30c.

The CPU 30a is, for example, a processor which executes a control program stored in the ROM 30b.

The ROM 30b is a read only memory that holds the control program and the like.

The RAM 30c is a volatile memory area and a readable memory used as a work area to be used when the CPU 30a executes the control program. Moreover, the RAM 30c temporarily holds images and the like captured by the imaging unit 12b.

The control unit 30 receives, via a bus 39, a command (signal) received by the communication interface unit 36 from an operating unit 38, and based on this command, controls the imaging unit 12b, the distance measuring unit 12c, the communication interface unit 36, the balance measuring unit 37, the mechanical unit 40, and the base securing unit 20.

On the basis of the control by the control unit 30, the imaging unit 12b captures an image by video of the travel surface on which the self-propelled robotic hand 10 propels itself.

On the basis of the control by the control unit 30, the distance measuring unit 12c measures the distance between the self-propelled robotic hand 10 and an object located in front of the self-propelled robotic hand 10.

The communication interface unit 36 receives commands from the operating unit 38 and transmits the commands to the control unit 30 via the bus 39. The communication interface unit 36 receives commands from the operating unit 38 via wireless data communication.

Wireless data communication is, for example, communication by a wireless LAN or infrared communication.

The balance measuring unit 37 measures the weight balance of the self-propelled robotic hand 10. The balance measuring unit 37 is, for example, a gyro sensor or an acceleration sensor.

The operating unit 38 is a dedicated terminal with a liquid crystal display that is capable of remotely controlling the self-propelled robotic hand 10. The liquid crystal display of the operating unit 38 includes a touch panel which detects touch controls (commands) made by the user to the operating unit 38. Moreover, the liquid crystal display of the operating unit 38 is capable of displaying images captured by the imaging unit 12b.

The operating unit 38, for example, transmits commands input by the user at the operating unit 38 to the communication interface unit 36 via wireless communication.

It should be noted that the operating unit 38 may be a commercially available hand-held or tablet device. In other words, the self-propelled robotic hand 10 may be controlled using a commercially available hand-held or tablet device.

Moreover, the operating unit 38 may be provided with a speech obtaining unit (microphone) in which case the self-propelled robotic hand 10 may be configured to operate according to voice commands made by the user.

The mechanical unit 40 includes the first joint 14c through the fifth joint 14g, the right wheel 18a, the left wheel 18b, the lever 22, motors 44a through 44h, and driving units 42a through 42h.

The first joint 14c through the fifth joint 14g, the right wheel 18a, the left wheel 18b, and the lever 22 are each associated with a corresponding one of the motors 44a through 44h and a corresponding one of the driving units 42a through 42h which drive the motors. For example, the driving unit 42a corresponds to and drives the motor 44a which is coupled to and moves the first joint 14c. Similarly, for example, the driving unit 42h corresponds to and drives the motor 44h which is coupled to and moves the lever 22.

On the basis of the controls by the control unit 30, the driving units 42a through 42e move the first joint 14c through the fifth joint 14g by driving the corresponding motors 44a through 44e.

Moreover, on the basis of controls by the control unit 30, the driving units 42f and 42g rotate the left wheel 18b and the right wheel 18a by driving the corresponding motors 44f and 44g. During this time, according to the output of the balance measuring unit 37, the control unit 30 controls the rotation of the wheels 18 in a manner so as to prevent the self-propelled robotic hand 10 from falling over. More specifically, the control unit 30 controls the weight balance of the self-propelled robotic hand 10 by individually controlling the rotational speed and rotational direction of the right wheel 18a and the left wheel 18b based on the changes in weight balance of the self-propelled robotic hand 10 measured by the balance measuring unit 37.

Moreover, on the basis of the control by the control unit 30, the driving unit 42h moves the lever 22 (base securing unit 20) by driving the corresponding motor 44h. In other words, the control unit 30 controls the retracting of the base 12 into and from the base securing unit 20.

The base securing unit 20 includes an electrostatic adhesion unit 24. On the basis of the control by the control unit 30, the electrostatic adhesion unit 24 secures the base 12 in place by electrostatically adhering to a surface of a structure. In other words, the control unit 30 controls the turning of the electrostatic adhesion of the base securing unit 20 on and off.

Next, an operation performed by the self-propelled robotic hand 10 will be described. In this non-limiting embodiment, as an example, an operation performed by the self-propelled robotic hand 10 inside a household will be described.

FIG. 7 is an operational flow chart of the self-propelled robotic hand 10.

FIG. 8 is a view showing an operation performed by the self-propelled robotic hand 10.

First, the self-propelled robotic hand 10 obtains a command from the user (S10 in FIG. 7). More specifically, the self-propelled robotic hand 10 obtains a command input by the user in the operating unit 38.

The self-propelled robotic hand 10 is capable of performing a specific operation in accordance with an abstract command from the user. The user inputs into the operating unit 38, for example, a relatively vague command such as “I want to drink juice”.

Next, the self-propelled robotic hand 10 begins moving according to the command from the user (S11 in FIG. 7). More specifically, the self-propelled robotic hand 10 moves, from a state in which it is set against a wall 52, as a result of the control unit 30 controlling the wheels 18. It should be noted that the self-propelled robotic hand 10 captures images of the travel surface using the imaging unit 12b while moving, and travels while confirming whether the travel surface is flat or not. Moreover, while traveling, the self-propelled robotic hand 10 measures a distance to an object in front of itself with the distance measuring unit 12c and confirms whether an obstacle is present or not based on the distance to the object.

The self-propelled robotic hand 10 holds a control program in the ROM 30b of the control unit 30. In the control program, for example, commands related to food and drink such as “I want to drink (blank)” and “I want to eat (blank)” are associated with an operation such as “move to the refrigerator, open the refrigerator door, retrieve an object, move to the location of the user”.

Moreover, the self-propelled robotic hand 10 holds, in the RAM 30c in the control unit 30, position information in which the positions of furniture and household electronics are mapped.

As such, when the command “I want to drink juice” is made, this position information is referred to, and, based on the above-described program, the self-propelled robotic hand 10 moves to the refrigerator 50 inside the household, as FIG. 8 shows.

Next, the self-propelled robotic hand 10 adheres the electrostatic adhesion unit 24 to the floor in front of the refrigerator 50 to secure the base 12 in place (S12 in FIG. 7).

More specifically, first, the control unit 30 recognizes the handle of the refrigerator 50 using an image of the refrigerator 50 captured by the imaging unit 12b. Pre-existing image recognition techniques are used to recognize the handle.

Next, the control unit 30 measures the distance to the handle of the refrigerator 50 from the self-propelled robotic hand 10 using the distance measuring unit 12c and, taking into consideration the length of the arm 14 and such, calculates an optimal position for grasping the handle of the refrigerator 50 and opening the door 50a.

The control unit 30 then controls the lever 22 to lower the base securing unit 20 onto the surface of the floor in an optimal position for opening and closing the refrigerator 50. The control unit 30 secures the base 12 in place by adhering the electrostatic adhesion unit 24 to the floor. At this time, since the self-propelled robotic hand 10 is secured to the surface of the floor, the control unit 30 stops the driving units 42f and 42g which rotate the wheels 18 in order to prevent the self-propelled robotic hand 10 from moving or falling over. This makes it possible reduce the power consumption of the self-propelled robotic hand 10.

Next, the self-propelled robotic hand 10 extracts the arm 14 (S13 in FIG. 7). More specifically, the control unit 30 extracts the arm 14 by controlling the first joint 14c and second joint 14d.

Next, the self-propelled robotic hand 10 performs a task instructed by the user (S14 in FIG. 7). More specifically, the control unit 30 first controls the first joint 14c through the fifth joint 14g so that the hand 16 (the long finger 16a and the short finger 16b) grasps the handle of the refrigerator 50 and opens the door 50a.

The control unit 30 then recognizes a can of juice from an image captured by the imaging unit 12b of the content of the refrigerator 50. At this time, the color and design of the can of the juice is held in advance in the RAM 30c, and the can of juice is recognized using image recognition techniques.

It should be noted that at this time, the control unit 30 may, for example, display the content of the refrigerator captured by the imaging unit 12b on the user's operating unit 38 and request the user to indicate a drink to be taken out of the refrigerator.

After the control unit 30 has recognized the can of juice, the self-propelled robotic hand 10 controls the first joint 14c though the fifth joint 14g with the control unit 30, and grasps the can of juice with the hand 16. At this time, when the self-propelled robotic hand 10 has difficulty grasping the can of juice from its current secured position, the control unit 30 temporarily releases the adhesion of the electrostatic adhesion unit 24, moves the self-propelled robotic hand 10 to an optimal position, re-adheres the electrostatic adhesion unit 24, then performs the controlling for grasping the can of juice.

After the control unit 30 causes the hand 16 to grasp the can of juice, the self-propelled robotic hand 10 moves to the position of the user. More specifically, the control unit 30 first releases the adhesion of the electrostatic adhesion unit 24. The control unit 30 then controls the lever 22 to store the base securing unit 20. Next, the self-propelled robotic hand 10 moves as a result of the control unit 30 controlling the wheels 18.

At this time, the position of the user is detected using wireless communication as described above to detect the position of the operating unit 38. It should be noted that, for example, the position of the user may be detected and temporarily stored in the RAM 30c by the control unit 30 upon obtaining a command from the user in S10 in FIG. 7. Moreover, by the user reporting in advance by voice command what piece of furniture or home electronic device he or she is near, the control unit 30 may obtain the position of the user by referring to the position information held in the RAM 30c in which the positions of furniture and household electronics are mapped.

The arm 14 remains in its extracted state while the self-propelled robotic hand 10 travels to the position of the user. During this time, there are instances in which the control unit 30 has difficulty controlling the wheels 18 and balancing the weight of the base 12 and the arm 14. In these instances, the control unit 30 temporarily controls the base securing unit 20 to secure the base 12, then controls the first joint 14c through fifth joint 14g to bring in the arm 14 so that balance is easier to maintain.

Next, after the self-propelled robotic hand 10 travels to the position of the user and hands over the can of juice, the self-propelled robotic hand 10 stores the arm 14 (S15 in FIG. 7). More specifically, the control unit 30 stores the arm 14 by controlling the first joint 14c and second joint 14d after first securing the base 12 in place by controlling the base securing unit 20.

Lastly, the self-propelled robotic hand 10 returns to its original location (S16 in FIG. 7). More specifically, the self-propelled robotic hand 10 returns to its original location as result of the control unit 30 controlling the wheels 18 after freeing the base securing unit 20 and the base 12. The original location refers to the state in which the self-propelled robotic hand 10 is set against the wall 52 as shown in FIG. 8. At this time, the self-propelled robotic hand 10 may close the refrigerator before returning to its original location.

It should be noted that the self-propelled robotic hand 10 confirms whether the travel surface is flat or not by analyzing the images obtained by the imaging unit 12b throughout the traveling described above.

When the self-propelled robotic hand 10 confirms that the travel surface is not flat from the images captured by the imaging unit 12b, the self-propelled robotic hand 10 further determines whether an obstacle is present on the travel surface or not.

When the self-propelled robotic hand 10 determines that an obstacle is present from the images captured by the imaging unit 12b, the self-propelled robotic hand 10 further removes the obstacle using the arm 14 and the hand 16.

FIG. 9 is an operational flow chart of such an obstacle removal operation performed by the self-propelled robotic hand.

First, the self-propelled robotic hand 10 captures the travel surface while traveling using the imaging unit 12b (S20). More specifically, the control unit 30 captures images of the travel surface using the imaging unit 12b.

Next, the self-propelled robotic hand 10 confirms whether the travel surface is flat or not (S21). More specifically, the control unit 30 analyzes the images captured by the imaging unit 12b using an image recognition technique to determine whether the travel surface is flat or not.

For example, the control unit 30 divides the captured images into a plurality of small regions and calculates the sum of absolute difference (SAD) for each region. The regions having a large SAD (in other words, the regions having a great change in color) are determined to be not flat. SAD is a parameter found by calculating the absolute difference in luminance between the pixels of one image and corresponding pixels from the next image in sequence on an one-to-one basis, then combining absolute difference in luminance values found for each pixel.

When the control unit 30 determines that the travel surface is flat (yes in S21), the self-propelled robotic hand 10 continues traveling.

When the control unit 30 determines that the travel surface is not flat (no in S21), the self-propelled robotic hand 10 further confirms whether an obstacle is present on the travel surface or not (S22). More specifically, the control unit 30 performs even further detailed analysis on the images captured by the imaging unit 12b to determine whether an obstacle is present on the travel surface or not.

For example, the control unit 30 is capable of recognizing an obstacle by calculating spikes in the change of luminance in the images captured.

At this time, the control unit 30 may further confirm an obstacle by measuring the distance to an object in front of the self-propelled robotic hand 10 with the distance measuring unit 12c.

When the control unit 30 determines that an obstacle is not present (no in S22), the self-propelled robotic hand 10 continues traveling.

When the control unit 30 determines that an obstacle is present (yes in S22), the self-propelled robotic hand 10 removes the obstacle using the arm 14 (S23).

It should be noted that the above is simply one example of the obstacle removal operation. For example, the confirming of the flatness of the travel surface and the confirming of the presence of an obstacle on the travel surface may be performed in parallel.

Moreover, in this non-limiting embodiment, the base securing unit 20 is retractable and only extracted when the base 12 needs to be secured to the travel surface by adhesion via the electrostatic adhesion unit 24. However, the control method of the base securing unit 20 is not limited to this example. For example, the distance between the base securing unit 20 and the travel surface may be controlled by vertically adjusting the wheels 18, rather than controlling the base securing unit 20.

FIG. 10 and FIG. 11 are views showing vertical adjustment of the wheels 18 to control the base securing unit 20.

FIG. 10 is a view showing the right side of the self-propelled robotic hand 10, and FIG. 11 is a view showing the self-propelled robotic hand 10 from the front and back.

In the views shown in FIG. 10 and FIG. 11, the base securing unit 20 is positioned on the bottom of the base 12 so that the electrostatic adhesion unit 24 is fixed in place to face the travel surface. On the other hand, the wheels 18 are vertically adjustable along the base 12.

As the left view in FIG. 11 shows, when the vertically adjustable wheels 18 are set in the lower end position on the base 12, the base securing unit 20 is separated from the travel surface. In other words, in this state, the self-propelled robotic hand 10 is capable of rotating the wheels 18 and traveling.

When the vertically adjustable wheels 18 are set in the upper end position on the base 12, the base securing unit 20 is in contact with the travel surface. In other words, in this state, the electrostatic adhesion unit 24 is capable of electrostatically adhering to the travel surface and securing the base 12 in place.

It should be noted that in this non-limiting embodiment, the base securing unit 20 is provided on a bottom that is a portion of the base 12 nearest the travel surface 12, but the position of the base securing unit 20 is not limited to this position. For example, the base securing unit 20 may be provided on a side surface of the base 12 (a surface on which at least one of the wheel 18s is attached). Moreover, the self-propelled robotic hand 10 may include a plurality of base securing units 20.

FIG. 12 is a view showing an example of the self-propelled robotic hand 10 provided with a base securing unit 21 on a side surface of the base 12, in addition to the base securing unit 20.

As FIG. 12 shows, the base 12 can be even more strongly secured in place by electrostatically adhering the electrostatic adhesion unit 24 of the base securing unit 20 provided on the bottom of the base 12 to the travel surface and electrostatically adhering the electrostatic adhesion unit of the base securing unit 21 provided on a side surface of the base 12 to the surface of a wall. Here, a side surface of the base 12 is a surface among the surfaces of the base 12 that are not parallel to the travel surface. In this non-limiting embodiment, the side surface include the surfaces of the base 12 on which the wheels 18 are provided, the surfaces on which the imaging unit 12b and the distance measuring unit 12c are implemented, and the surface on which the base securing unit 20 is provided.

Moreover, when an object installed inside the building is, for example, an object that is heavy such as a refrigerator (generally, the weight of a 500 liter capacity refrigerator is roughly 80 kg or more), the object is considered to be secured to the surface of the floor, which means the base 12 can be secured to any surface of the refrigerator besides the door and the door can be opened and closed.

This concludes the description of the self-propelled robotic hand 10 according to this non-limiting embodiment. With this disclosure, a light-weight and compact self-propelled robotic hand 10 can be realized by providing the self-propelled robotic hand 10 with a base securing unit which secures the base 12 in place with electrostatic adhesion.

It should be noted that in the above non-limiting embodiment, the self-propelled robotic hand 10 is described as being provided with the wheels 18, but the self-propelled robotic hand may be provided with legs instead of the wheels 18.

FIG. 13 is an external view of the self-propelled robotic hand provided with legs.

As (a) in FIG. 13 shows, a self-propelled robotic hand 60 is provided with and travels (walks) on the travel surface with four legs 28a through 28d.

Moreover, as (b) in FIG. 13 shows, the self-propelled robotic hand 60 is capable of storing the folded up legs 28a through 28d in the base 12. With this, the self-propelled robotic hand 60 is capable of electrostatically adhering the electrostatic adhesion unit of the base securing unit 20 to the travel surface. It should be noted that the base securing unit 20 may be provided on the surfaces of the legs 28a through 28d that come in contact with the travel surface (in other words, the bottom portions of the feet).

As the above, the non-limiting embodiment has been described by way of example of the technology of the present disclosure. To this extent, the accompanying drawings and detailed description are provided.

Thus, the components set forth in the accompanying drawings and detailed description include not only components essential to solve the problems but also components unnecessary to solve the problems for the purpose of illustrating the above non-limiting embodiment. Thus, those unnecessary components should not be deemed essential due to the mere fact that they are described in the accompanying drawings and the detailed description.

The above non-limiting embodiment illustrates the technology of the present disclosure, and thus various modifications, permutations, additions and omissions are possible in the scope of the appended claims and the equivalents thereof.

### INDUSTRIAL APPLICABILITY

The self-propelled robotic hand according to the present disclosure is a light-weight, compact robot capable of securing its base in place in a variety of locations, and is applicable as an assistance and health care robot designed for household use, for example.

1. A self-propelled robotic hand comprising:
a base capable of self-propulsion;
an arm attached to the base;
a hand attached to the arm, the hand being for grasping an object; and
a base securing unit attached to the base and configured to secure the base in place by electrostatic adhesion to a surface of a structure external to the self-propelled robotic hand.

2. The self-propelled robotic hand according to claim 1,
wherein the base propels itself on a travel surface, and
the base securing unit is attached to a bottom or a side of the base, the bottom being a portion of the base nearest the travel surface.

3. The self-propelled robotic hand according to claim 1,
wherein when the self-propelled robotic hand is used inside a building, the surface of the structure to which the base securing unit electrostatically adheres is a surface of a floor of the building, a surface of a wall of the building, or a surface of an object installed inside the building.

4. The self-propelled robotic hand according to claim 1,
wherein the base securing unit is retractable from the base.

5. The self-propelled robotic hand according to claim 1,
wherein the base includes a wheel for propelling itself on a travel surface, the wheel being adjustable in a vertical direction, and
the base securing unit is attached to the base in a position which allows the base securing unit to be separated from the travel surface when the wheel is set in a lower end position in the vertical direction and electrostatically adherable to the travel surface when the wheel is set in an upper end position in the vertical direction.

6. The self-propelled robotic hand according to claim 1,
wherein the base includes a storage space for storing the arm and the hand.

7. The self-propelled robotic hand according to claim 1,
wherein the base includes a control unit configured to turn on and off the electrostatic adhesion of the base securing unit.

8. The self-propelled robotic hand according to claim 7, further comprising
an imaging unit configured to capture an image of a travel surface on which the base propels itself,
wherein the control unit is configured to confirm whether the travel surface is flat by analyzing the image captured by the imaging unit.

9. The self-propelled robotic hand according to claim 8,
wherein when the control unit confirms that the travel surface is not flat, the control unit is configured to determine whether an obstacle is present on the travel surface and, when an obstacle is determined to be present, remove the obstacle using the arm and the hand.
